(19) United States
(12) Patent Application Publication
(10) Pub. No.: US 2006/0143521 A1
(43) Pub. Date: Jun. 29, 2006

(54) METHOD FOR EXTRACTING DYNAMICAL OUTPUT MESSAGES FROM SOFTWARE SOURCE CODES

(76) Inventor: Yu-Ming Lang, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/163,401

(22) Filed: Oct. 18, 2005

(30) Foreign Application Priority Data
Dec. 10, 2004 (TW) 093138251

(51) Int. Cl. G06F 11/00

(52) U.S. Cl. 714/26

(57) ABSTRACT

The present invention provides a method for extracting a dynamical output message from software source codes (10). The method includes the steps of: declaring a variable in the software source codes; assigning the dynamical output message to the variable as a value of the variable; storing the value of the variable into a section of the software source codes; extracting the value of the variable from the section to create a dynamical link library; and building a software package on a base of the software source codes not including the dynamical output message. A method for outputting a dynamical output message linked to a software package is also provided.

### FIELD OF THE INVENTION

The present invention is generally related to methods for building a software package, and, more particularly, is related to methods for extracting dynamical output messages from software source codes.

### DESCRIPTION OF RELATED ART

Typically, a software package outputs messages showing errors when errors occur during execution. Theses messages are dynamical output messages outputted only on special conditions. For example, if a user inputs a negative integer by error when a positive integer is expected, the software may output a message reciting “You must input a positive integer here, thanks!” through a display device However, the message need not be outputted as long as the user inputs a positive integer carefully. In this regard, the message is a kind of dynamical output messages.

Dynamical output messages are not essentials to a software package, but take up certain size of the software. Additionally, dynamical output messages cut down efficiency and speed of software execution. A programmer always needs to build two software packages, one including the dynamical output messages, the other not including the dynamical output messages.

However, software source codes would be greatly changed if two software packages are built. Greatly changing the software source codes is tough to a programmer, and possibly results in many problems hard to solve.

Therefore, what is needed is a method for extracting dynamical output messages from software source codes which do not need to build two different software packages for a software.

### SUMMARY OF INVENTION

One embodiment of the present invention provides a method for extracting a dynamical output message from software source codes. The method includes the steps of: declaring a variable in the software source codes; assigning a dynamical output message to the variable as a value of the variable; storing the value of the variable into a section of the software source codes; extracting the value of the variable from the section to create a dynamical link library; and building a software package on a base of the software source codes not including the dynamical output message.

Another embodiment of the present invention provides a method for outputting a dynamical output message linked to a software package The method includes the steps of: declaring a variable in a software source codes; assigning the dynamical output message to the variable as a value of the variable; storing the value of the variable into a section of the software source codes; extracting the value of the variable from the section of the software source codes to create a dynamical link library; building the software package on a base of the software source codes not including the dynamical output message; searching in the dynamical link library for the variable value; and outputting the dynamical output message.

### BRIEF DESCRIPTION OF DRAWINGS

FIG. 1 is a schematic diagram of extracting dynamical output messages from software source codes, in accordance with one embodiment of the present invention;

FIG. 2 is a flowchart illustrating a method of extracting a dynamical output message from software source codes, in accordance with one embodiment of the present invention; and

FIG. 3 is a flowchart illustrating a method of outputting a dynamical output message linked to a software package, in accordance with one embodiment of the present invention.

### DETAILED DESCRIPTION

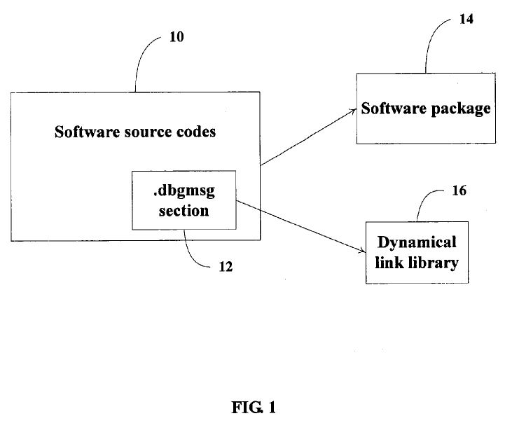

FIG. 1 is a schematic diagram of extracting dynamical output messages from software source codes, in accordance with one embodiment of the present invention. The software source codes 10 typically include object codes which can be executed by a data processing system (DPS), such as a personal computer (PC). The software source codes 10 may further include some dynamical output messages, such as messages showing errors to a user when the software is executed. The dynamical output messages may be displayed on a display device, such as a monitor of the DPS. A programmer may define a plurality of sections in the software source codes 10, in order to arrange various kinds of codes and data when compiling the software source codes 10. For example, a .code section is defined for storing object codes of the software source codes 10; a .data section is defined for storing data which have been initialized, such as strings; a .bss section is defined for storing data which have not been initialized. In the preferred embodiment, a .dbgmsg section 12 is defined for storing the dynamical output messages. When the programmer builds the software source codes 10, contents of the .dbgmsg section 12 of the software source codes 10 are compiled and extracted to create a dynamical link library (DLL) 16 by a linker, and all other sections of the software source codes 10 are compiled into corresponding object codes to create a software package 14 by the linker. Both the software package 14 and the DLL 16 can be offered to the user. If the user is not familiar enough with the software, he or she may need to execute both the software package 14 and the DLL 16, and the dynamical output messages in the DLL 16 may be outputted when errors occur. On the other hand, if the user is familiar enough with the software, and wants to enhance efficiency and speed of executing the software, he or she may only choose to execute the software package 14, therefore, the dynamical output messages will not be outputted even if errors occur.

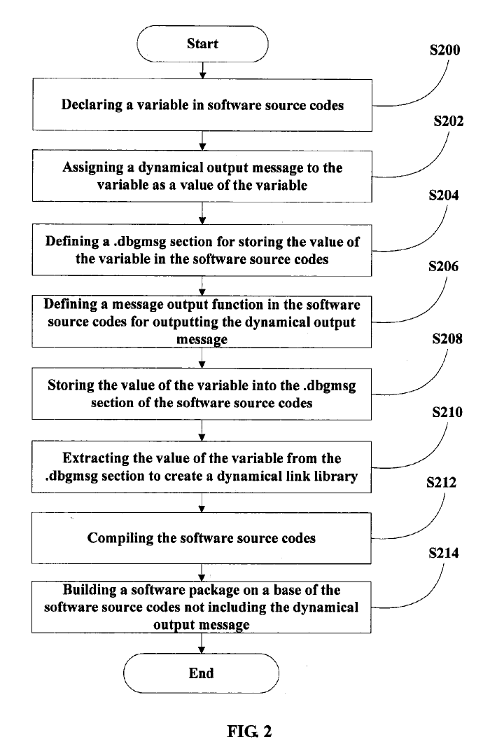

FIG. 2 is a flowchart illustrating a method for extracting a dynamical output message from the software source codes 10, in accordance with one embodiment of the present invention. In step S200, a variable is declared in the software source codes 10. In step S202, the dynamical output message is assigned to the variable as a value of the variable. In step S204, a .dbgmsg section 12 is defined for storing the value of the variable in the software source codes 10. In step S206, a message output function is defined in the software source codes 10 for outputting the dynamical output message. In step S208, the value of the variable is stored into the .dbgmsg section 12. In step S210, contents of the .dbgmsg section 12 are compiled and extracted to create a dynamical link library 16 by a linker. In step S212, the other sections of the software source codes 10 are compiled to corresponding object codes by the linker. In step S214, a software package 14 are created based upon the object codes.

To supplement, not to limit, the above description of the method, following is an example paragraph of codes of the software source codes 10 which are programmed with C programming language. It should be noted that those skilled in the art can read and understand the following codes with C programming language, and can easily to convert the codes into other programming languages.

LINE1: int get_user_input(void)
LINE2: {
LINE3: int a;
LINE4: printf(“Please input a postive integer :”);
LINE5: scanf(“%d”, &a);
LINE6: if (a < 0)
LINE7: {
LINE8: error_message_output(“Your input is not a positive
integer !”);
//outputting a dynamical output message
LINE9: }
LINE10: return a;
LINE11: }

In LINE8, the codes intend to call a message output function named as “error_message_output”, in order to output a message “Your input is not a positive integer !” to the user on a monitor. The message output function “error_message_output” is defined in the software source codes 10 as following.

```
    LINE12:  #define error_message_output(message) \
    LINE13:  { \
    LINE14:  static char
    msg##_{——}LINE_{——}[ ]_{——}attribute_{——}((section(“.dbgmsg”)) =
message; \
    LINE15:  find_and_message_output(msg##_{——}LINE_{——}); \
    LINE16:  }
```

In LINE 14, a variable “msg##_LINE_” is declared. The “##_LINE_” is replaced by the LINE number where the message output function “error_message_output” is called. In this example, the “msg##_LINE_” is replaced by msg8 in LINE14 and LINE15. That is, the message “Your input is not a positive integer !” is assigned to the variable “msg8” as a value of the variable “msg8”. Additionally, in LINE14, “[ ] _attribute_((section(“.dbgmsg”))=message” means storing the value of the variable “msg8” into a pre-defined section “.dbgmsg” 12. In LINE15, another message output function “find_and_message_output” is called, whose definition is given in the following context. In conclusion with the codes from LINE1 to LINE16, the message “Your input is not a positive integer !” is assigned to the variable “msg8”, and then stored into the pre-defined “.dbgmsg” section 12.

It should be noted that the method, as set forth above, can further be utilized to extract a plurality of dynamical output messages (if any) from the software source codes 10. In detail, the solution can be described for example as: declaring a plurality of variables; assigning the dynamical output messages to the variables as values of the variables respectively; storing the values of the variables to the .dbgmsg section 12; extracting all the values from the .dbgmsg section 12 to create a DLL 16; building a software package 14 not including the dynamical output messages.

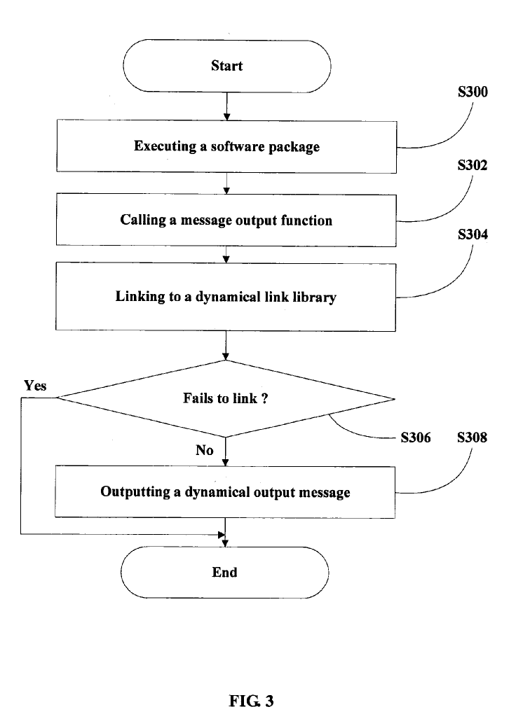

FIG. 3 is a flowchart illustrating a method for outputting a dynamical output message linked to a software package 14, in accordance with one embodiment of the present invention. In step S300, a user executes the software package 14 in a DPS, such as a PC. If any error occurs in executing the software package 14, such as inputting a negative integer while a positive integer is expected, in step S302, the software package 14 calls a message output function, such as the function “error_message_output” in the software source codes 10 as set forth above in relation to FIG. 2, in order to output a message showing the error information to the user. Once the “error_message output” function is called, in step S304, the software package 14 links to the DLL 16 which includes the variable “msg8” and its value, and searches in the DLL 16 for the variable “msg8” to show the value “Your input is not a positive integer!” In step S306, the software package 14 determines whether linking to the DLL 16 succeeds. If the software package 14 succeeds in linking to the DLL 16, in step S308, the software package 14 outputs the dynamical output message on a monitor. If the software package 14 fails to link to the DLL 16, the procedure ends.

To supplement, not to limit, the above description of the method, following is a example paragraph of codes of the software source codes 10 which are programmed with C programming language. The part of codes, from LINE17 to LINE41, is the definition of the message output function “find_and_message_output” as called in LINE15.

LINE17: int find_and_message_output(const char *symb)
LINE18: {
LINE19: void *dlh=NULL;
LINE20: char *message=NULL;
/*
*try to search the DLL (step S304)
*/
LINE21: if ((dlh=dlopen(“libdbgmsgxxx.so.1.0.0”, RTLD_LAZY)) ==
NULL)
LINE21: {
//---> go here if the DLL is not searched
LINE22: return 0;
LINE23: }
LINE24: dlerror( );
/*
* search the variable msg8 in the DLL
* (msg8 is replace by symb here)
* /
LINE25: if ((message=(char *)dlsym(dlh, symb)) == NULL &&
dlerror( ))
LINE26: {
//--> msg8 is not searched
LINE27: dlclose(dlh);
LINE28: return 0;
LINE29: }
LINE30: if (message)
LINE31: {
LINE32: int rc;
LINE33: rc = fprintf(stderr, message); //output the debug message
LINE34: dlclose(dlh);
LINE35: return rc;
LINE36: }
LINE37: else
LINE38: {
LINE39: dlclose(dlh);
LINE40: return 0;
LINE41: }

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A method for extracting a dynamical output message from software sources codes, the method comprising the steps of:
declaring a variable in the software source codes;
assigning a dynamical output message to the variable as a value of the variable;
storing the value of the variable into a section of the software source codes;
extracting the value of the variable from the section to create a dynamical link library; and
building a software package on a base of the software source codes not including the dynamical output message.

2. The method according to claim 1, further comprising the step of defining the section for storing the value of the variable in the software source codes.

3. The method according to claim 1, further comprising the step of defining a message output function in the software source codes for outputting the dynamical output message.

4. The method according to claim 1, further comprising the step of compiling the software source codes before the building step.

5. A method for outputting a dynamical output message linked to a software package, the method comprising the steps of:
declaring a variable in software source codes;
assigning the dynamical output message to the variable as a value of the variable;
storing the value of the variable into a section of the software source codes;
extracting the value of the variable from the section of the software source codes to create a dynamical link library;
building the software package on a base of the software source codes not including the dynamical output message;
searching in the dynamical link library for the variable value; and
outputting the dynamical output message.

6. The method according to claim 5, further comprising the step of executing the software package.

7. The method according to claim 5, wherein the dynamical output message is a message showing errors when executing the software package.

8. The method according to claim 5, further comprising the step of compiling the software package before the building step.

9. The method according to claim 5, further comprising the step of linking the software package to the dynamical link library.

10. The method according to claim 5, further comprising the step of defining a message output function in the software source codes for outputting the dynamical output message.

11. The method according to claim 10, wherein the searching step is triggered by calling the message output function.

12. The method according to claim 5, further comprising the step of defining the section for storing the value of the variable in the software source codes.
